(19) United States
(12) Patent Application Publication
(10) Pub. No.: US 2014/0373530 A1
(43) Pub. Date: Dec. 25, 2014

(54) MULTI-FUEL ENGINE

(71) Applicant: William de Ojeda, Oak Park, IL (US)

(72) Inventor: William de Ojeda, Oak Park, IL (US)

(73) Assignee: International Engine Intellectual Property Company, LLC, Lisle, IL (US)

(21) Appl. No.: 14/373,773

(22) PCT Filed: Jan. 27, 2012
(86) PCT No.: PCT/US12/22838

§ 371 Date: Jul. 22, 2014

(51) Int. Cl. F02M 43/00; F02B 47/08

(52) U.S. Cl. CPC F02M 43/00; F02B 47/08
USPC 60/603; 60/273

(57) ABSTRACT

Engine includes an air induction sub-system for delivery of air to each cylinder. A lowpressure fuel injector injects a low reactivity fuel into the sub-system. An exhaust gas recirculation line connects exhaust gas purged from the cylinders back to the sub-system. An exhaust gas cooler cools recirculated gas in the exhaust gas recirculation line. The quantity of exhaust gas recirculated is controlled and the recirculated gas provides dilution and temperature control of the charge to suppress auto-ignition of the charge in the cylinder. A high pressure fuel injector injects a high reactivity fuel in the compression stroke for auto ignition and to initiate combustion of the charge. A variable valve actuator controls compression ratio and cylinder peak temperature. Boost is provided in air induction sub-system to assure combustion to stoichiometric levels.

### TECHNICAL FIELD

The disclosure relates to reciprocating internal combustion engines, and in particular relates to auto-ignition engines providing concurrent combustion of fuels of differing reactivity indices.

### BACKGROUND

Compression ignition engines, particularly diesel cycle engines, provide power for many trucks and an increasing number of automobiles throughout the world. The efficiency of diesel engines compares favorably with widely used spark ignition engines, but diesel engines emission of particulates and to compounds of nitrogen and oxygen are subject to legal restriction.

Historically, the four stroke compression ignition engine widely used in motor vehicles has worked by drawing air into an engine cylinder during a down/draw stroke of the cylinder's piston, compressing the air on a subsequent up/compression stroke of the piston and injecting fuel into the cylinder as or just after the piston reaches the top of its compression stroke. The compression of the air results in increasing air temperature which in turn leads to ignition and combustion of the fuel in the cylinder as the fuel is injected. The combustion of the fuel with oxygen from the air increases pressure in the cylinder and powers the ensuing down or power stroke of the piston. The combustion by-product or exhaust is purged/scavenged from the cylinder during the following up stroke and the cycle repeats. The cylinder is provided with at least one intake valve which opens for the draw stroke and at least one exhaust valve which opens for the exhaust stroke. The timing of intake and exhaust valve opening and closure were controlled by a cam shaft and the timing of their operation has been fixed relative to the position of the piston.

Basic diesel operation has been modified by changes to the engines and the addition of electronic control. Engine modifications have included: the recirculation of exhaust gas back to the intake manifold (exhaust gas recirculation or EGR); a cooler in the EGR line; hydraulically controlled valve lifters, particularly intake valve lifters which has allowed varying the timing of valve opening and closing (called variable valve actuation (VVA)); solenoid control over hydraulic fuel injectors; and turbocharging. Electronic control over these elements in turn permits: selection of the timing, time duration and pressure of fuel injection; varying of the pressure boost to intake air; varying of the engine compression ratios by varying intake or exhaust valve timing; and varying the temperature of the intake air. The ability to partially control these operational variables in turn increases control over the timing, progression and temperature at which combustion occurs. As a result engine operation can be varied dynamically in response to immediate vehicle conditions.

Concurrent combustion of a plurality of fuels in a compression ignition engine is also known. This involves intake port or intake manifold injection of the lower reactivity fuel (e.g. gasoline) during the draw cycle and direct in-cylinder injection of high-reactivity fuel (e.g. diesel). The more highly reactive fuel has been injected near the top dead center (TDC) position of a piston at the end of a compression stroke. Near TDC injection of the higher reactivity fuel directly into the cylinder provides combustion stability yet reduces the impact of the dual fuels in the emission output and the efficiency of the combustion process. Pressure rise rates have been limited by de-rating the engine (lowering the power output) or lowering the compression ratio. Implementation of the process has entailed providing fuel and charge air amounts to ensure sufficiently premixed conditions throughout the speed and torque map for the engine with combustion phasing meeting efficiency and pressure rise rate target values.

### SUMMARY

A reciprocating engine system for a vehicle includes cylinders with each cylinder having at least one intake valve and one exhaust valve. Charge air is drawn into each cylinder through the intake valve and compressed to support combustion in the cylinder. An air induction sub-system provides for delivery of air to each cylinder. A low pressure fuel injector connected to inject a fuel into the air induction sub-system. An exhaust gas recirculation line connects exhaust gas purged from the cylinders back to the air induction sub-system. Recirculated exhaust gas is cooled using an exhaust gas cooler in the exhaust gas recirculation line. The quantity of exhaust gas recirculated is controlled and the recirculated gas used to provide dilution and temperature control of the charge to suppress auto-ignition of the charge in the cylinder. A high pressure fuel injector coupled directly into the cylinder injects fuel at or near a level of peak compression for auto ignition and to initiate combustion of the charge. A variable valve actuator may be used with the intake or exhaust valve to extend control over the compression ratio and cylinder peak temperature.

The low pressure fuel injector is supplied from a source of relatively low reactivity fuel and the high pressure fuel injector is supplied from a source of relatively high reactivity fuel. A low pressure compressor and a high pressure compressor are connected in series in the induction system to boost intake air pressure and to enable combustion to occur at least to stoichiometric levels. An intercooler is coupled between the low pressure and the high pressure compressors and a charge air cooler coupled between the high pressure compressor and the intake valve to implement further control over air temperature on intake to the cylinder. A combustion phase sensor maybe coupled to the cylinder to provide combustion phase data to an engine control module which in turn provides supervisory control over variable valve actuation timing, adjust the charge air mixture ratio, flow and temperature.

### BRIEF DESCRIPTION OF THE DRAWINGS

FIG. 1 is a general schematic diagram of a motor vehicle multi-fuel engine system.

FIG. 2 is a schematic of a cylinder of the multi-fuel engine system of FIG. 1.

FIG. 3 is engine torque over engine rpm illustrating a plurality of combustion modes used to achieve the torque results.

FIG. 4 is a general schematic diagram of a single fuel type motor vehicle engine system.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting.

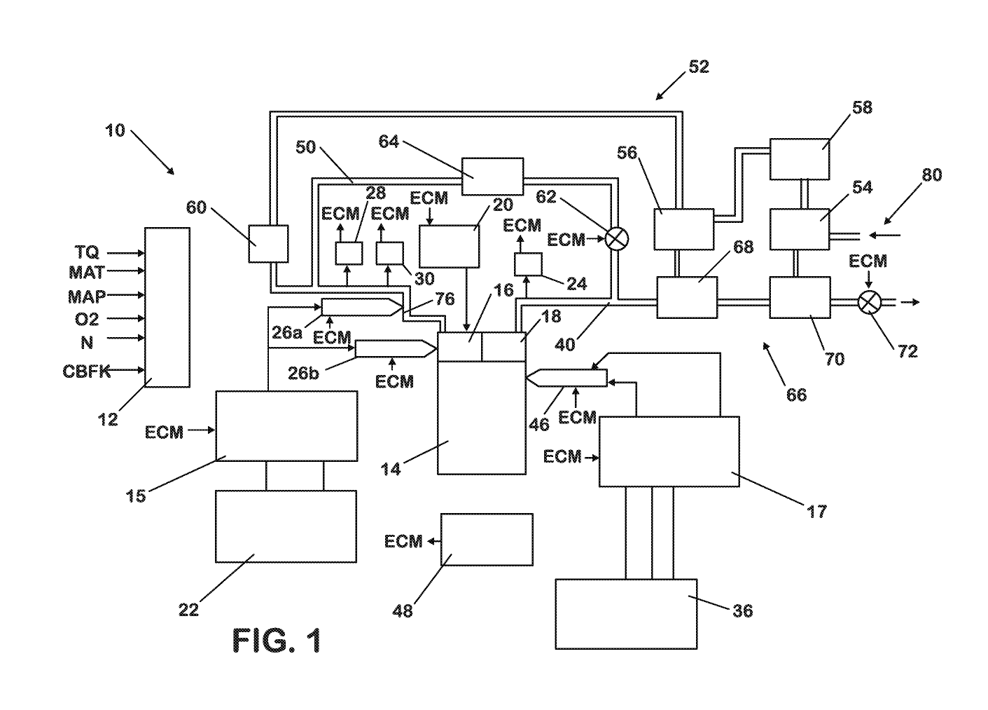

Referring to FIG. 1, an engine system 10 is shown which is a reciprocating compression ignition engine which can concurrently burn fuel of different reactivity indices. In a configuration for combustion of two fuel types, here characterized as “low reactivity” and “high reactivity,” a low pressure fuel injection system 15 draws a low reactivity fuel such as gasoline or natural gas from fuel source 22 and delivers the fuel to a manifold injector 26a or to a port injector 26b for each cylinder. Natural gas is an example of a fuel for which a manifold injector 26a is used while gasoline is an example of a fuel for which a port injector 26b is used. The high pressure fuel injection system 17 draws high reactivity fuel from fuel source 36 to supply in-cylinder injectors 46 for each cylinder of engine 14. Diesel grade fuels would be a high reactivity fuel in comparison to natural gas or gasoline.

Air management for engine system 10 includes an air induction sub-system 52, an exhaust sub-system 66 and an exhaust gas recirculation (EGR) line 50. The air induction sub-system draws air from the environment and boosts its pressure to support combustion of fuel. The exhaust sub-system 66 receives combustion by-products from engine 14 and may provide turbines 68, 70 to extract mechanical energy from the combustion by-products before releasing exhaust gas back to the environment after treatment (not shown). The EGR line 50 recirculates a controlled quantity of exhaust gas from the exhaust sub-system 66 back to the air induction sub-system 52 and more particularly to an intake manifold 76.

A turbocharger sub-system 80 provides for extraction of energy from the exhaust sub-system 66 to boost air pressure in the induction sub-system 52 and to retain sufficient backpressure in the exhaust manifold 40 to force recirculated exhaust gas into an intake manifold 76. The turbocharger sub-system 80 comprises a high pressure turbine 68 and a low pressure turbine 70 positioned in series downstream from the exhaust manifold 40 in the exhaust sub-system 66. High pressure turbine 68 is mechanically coupled to drive a high pressure compressor/supercharger 56 and low pressure turbine 70 is mechanically coupled to drive a low pressure compressor/supercharger 54.

The low and high pressure compressors 54, 56 are located in series in the air induction sub-system 52. Compressed air from low pressure compressor 54 is directed to high pressure compressor 56 through an intercooler 58 which extracts heat from the intake air and thereby reduces its temperature. Compressed air from high pressure compressor 56 flows through a high pressure stage cooler 60 into the intake manifold 76 where it is mixed with recirculated exhaust gas. Mechanically or electrically powered superchargers may be substituted for one or both compressors 54, 56, with a loss of energy recapture from the exhaust. Such a change would allow simplification of the exhaust sub-system 66 and allow direct control over pressure in the exhaust manifold 40. The mixture delivered to the intake port includes low-reactivity fuel if manifold injection 26a is used.

Exhaust sub-system 66 carries exhaust from an exhaust port 18 (which includes an exhaust valve) through the high pressure turbine 68 and the low pressure turbine 70. An exhaust valve 72 connects exhaust from the low pressure turbine to the environment. Exhaust valve 72 is used during engine 14 start to force maximum exhaust gas recirculation. The EGR line 50 is connected to the exhaust sub-system 66 upstream from the high pressure turbine 68 and discharges into the intake manifold 76 upstream from the intake port 16 and downstream from the high pressure stage cooler 60. EGR line 50 includes an EGR control valve 62 which controls the portion of exhaust gas from exhaust manifold 40 which is recirculated after engine 14 has warmed to normal operating levels and an EGR cooler 64 for reducing the temperature of the recirculated exhaust gas.

A four cycle combustion process of drawing a charge of air, recirculated exhaust gas and low reactivity fuel, compressing the charge, combustion and purging of exhaust gas is implemented in engine 14 using low reactivity fuel and air introduced through intake port 16 during the draw cycle. High reactivity fuel may be introduced by in-cylinder injector 46 during the piston compression stroke. High reactivity fuel is introduced one or more times near completion of the compression stroke (top dead center or “TDC”) for auto-ignition. The energy released from auto-ignition ignites the low reactivity fuel and remaining high reactivity fuel.

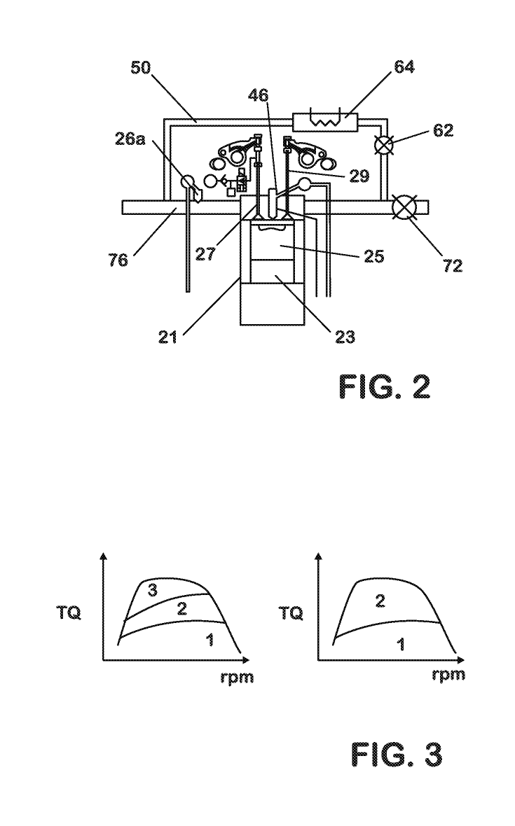

An engine control module (ECM) 12 manages the combustion process in response to engine 14 operating conditions and at least one exogenous variable. Inputs to ECM 12 can come from several sources. An intake manifold pressure sensor 28 reports manifold air pressure (MAP) to ECM 12. An intake manifold air temperature sensor 30 reports manifold air temperature (MAT). An oxygen sensor 24 in the exhaust manifold 40 reports exhaust oxygen levels (O2). A combustion phase sensor 48, if present, communicates with the interior of cylinder 21 (see FIG. 2) and provides for detection of ignition and combustion in the cylinder. Combustion phase sensor 48 is usually a pressure sensor or an ion sensor. Data generated by combustion phase sensor 48 is transmitted to ECM 12 as a combustion feedback signal (CBFK). A tachometer (not shown) generates an engine speed signal (N). A torque demand (TQ) signal may be considered as being generated externally. The engine speed signal (N) may and the torque demand signal (TQ) will usually be received by ECM 12 over a network from relatively remote sources. TQ is usually related to an accelerator position signal mediated by a vehicle body computer (not shown). If available an induction air mass sensor may provide a signal as well.

A number of elements are controlled by ECM 12 to manage engine 14 operation. A variable valve actuator (VVA) 20 controls opening and closing of an intake valve in the intake port 16. VVA 20 allows for varying the timing/phase of opening of the intake valve of intake port 16 relative to piston position. For example, the intake valve may be kept closed for part of the draw stroke which in effect reduces the intake displacement of a cylinder for a given cycle. This effectively temporarily reduces engine 14 compression. ECM 12 applies control signals to the low and high pressure fuel injection systems allowing it to set operating pressures. ECM 12 controls the timing, number and duration of injection pulses of fuel by injectors 26a, 26b and, most importantly, injector 46 for each engine 14 cylinder and for each combustion stroke in a cylinder. ECM 12 also controls the position of EGR control valve 62 in order to control the proportion of exhaust gas recirculated to the intake manifold 76. This changes the boost provided intake air by compressors 54 and 56.

Integrated engine strategies can now be considered. Fuel injection is provided both in the induction sub-system 52, either by way of the intake manifold 76 or intake port 16, and directly into the cylinder 21 using injector 46. Metering is provided of both fuel types. In-cylinder injection pressure levels greater than 300 bar up to systems capable of 3000 bar are provided.

EGR line 50 is capable of recirculating 30% to 60% of exhaust gas to the intake manifold. EGR cooler 64 cools the recirculated exhaust gas to a temperature near, but above, the condensation temperature of water. The multi-turbocharger configuration of turbocharger sub-system 80 (low pressure and high pressure compressors 54, 56) provides delivery of enough oxygen to maintain combustion at lean to stoichiometric levels. VVA 20 provides for control over the intake valve of the intake port 16. Variable valve actuation may be extended to the exhaust valve (not shown). Combustion feedback control via in-cylinder combustion phase sensor 48 or physical modeling of the combustion event is used.

Referring to FIG. 2, a representative cylinder 21 from engine 14 is shown. Cylinder 21 encloses a reciprocating piston 23 which is used to vary the volume of a combustion chamber 25. An intake valve 27 and an exhaust valve 29 may be used to connect the combustion chamber 25 to the intake manifold 76 and to the exhaust manifold 40. Valve 72 in the exhaust manifold 40 represents restrictive features of the exhaust manifold used to generate backpressure which urges some portion of exhaust gas to recirculate to the intake manifold 76 through EGR line 50. A manifold fuel injector 26a provides for injection of low reactivity fuel into the intake manifold 76 and an in-cylinder injector 46 provides for injection of high reactivity fuel directly into combustion chamber 25.

Concurrent combustion of multiple fuels in reciprocating engine 14 is done using a premixed charge air and recirculated exhaust gas with a low reactivity fuel (typically inserted into the intake port 16 for gasoline like fuels or into the intake manifold 76 for natural gas) and direct injection high-reactivity fuel (typically Diesel) into the combustion cylinder 21. One or more high-reactivity injection events (multiple shots) may be used. The timing of the injection of high-reactivity fuel will range from early in the compression stroke (yielding nearly premixed conditions) to closer to TDC. The combination of dual fuel injection, in-cylinder combustion charge mixture and compression ratio control through variable valve actuation and exhaust gas level, and combustion sensing feedback for combustion adjustments in a cycle-to-cycle basis allows flexibility in setting fuel reactivity. Dynamically varying the compression ratio effects engine 14 output, but the effect is not persistent.

Multiple combustion modes are achieved through specific fuel injection strategies and variable valve actuation control coupled with combustion feedback to expand the robust operating range of premixed combustion. Improved efficiency (approximately 5-10% over current 2010 benchmarks) and the possible elimination NOx after-treatment due to lower operating temperature may be achieved by use of these combustion modes.

In general the injection of a low reactivity fuel and a high-reactivity fuel is distributed between a lower pressure system for port or manifold injection of the low reactivity fuel and high pressure in-cylinder injection for the high reactivity fuel. Recirculated exhaust gas is mixed with induction air and low reactivity fuel charge and the mixture is delivered by port injector 26b for an engine cylinder. Recirculated exhaust gas suppresses autoignition of the fuel/gas/air mixture drawn into cylinder 21 before injection of fuel by the high pressure in-cylinder injector 46 at or near TDC of piston 23. The recirculated exhaust gas is cooled and mixed with the air from the induction sub-system 52. The induction air is cooled by high pressure stage cooler 60 and intercooler 58. Manifold temperature of the charge and the degree of dilution of the charge with exhaust gas are targeted to control auto-ignition. The turbo-charger system 80 is a high boost system encompassing a multi-stage compressor setup within turbo-charger sub-system 80 comprising low and high pressure compressors 54, 56 and intercooler 58 to provide the sufficient air to run the system at lean to stoichiometric levels (for efficiency) and provide sufficient pressure to enhance the reactivity of the mixture in the presence of high exhaust gas recirculation rates. The VVA 20 coupled to the intake port 16 provides further in-cylinder cooling by controlling the compression ratio and for control over charge air-to-fuel ratio and oxygen concentration. Combustion feedback data is provided either through combustion phase sensing or trough modeling of the combustion phenomenon.

The different combustion modes provide a functional approach to implement dual fuel combustion in engine system 10. The constraints of auto-ignition and excess pressure rise rates have limited the use of low reactivity fuels, for example gasoline. EGR, cooling and variable valve actuation allow the extended use of the low-reactivity fuel over a varied engine system 10 operating conditions and effectively extend the use dual fuels to higher loads, retaining the engine efficiency as illustrated in FIG. 3 over a wide torque curve (TQ) with the left hand graph illustrating the presently disclosed strategy applied to engine system 10. The figure illustrates areas (1) associated with highest use of high-reactivity fuel, (2) associated with the use premixed fuel and charge air with control over combustion phasing by fuel reactivity, and (3) an area where the level of premixed fuel ahead of TDC is limited to avoid to early autoignition. Area (2) shows the benefits from a combustion efficiency and emissions perspective moving from the left hand graph to the right hand graph limiting or eliminating the early auto-ignition region (3). The accurate metering of the fuel ratio or overall reactivity provides control over the combustion timing through the combined effect of these engine system 10 features to establish the conditions to extend the use of the highly-premixed fuel mixture across the entire engine map, especially at the high load regimes.

The introduction of two combustion modes to utilize the fuel reactivity properties provided by multi-fuels produces reduces engine emissions with NOx and PM below the 2010 US regulations while improving the engine efficiency. The effect of the system integration extends the operation of the premix characteristics.

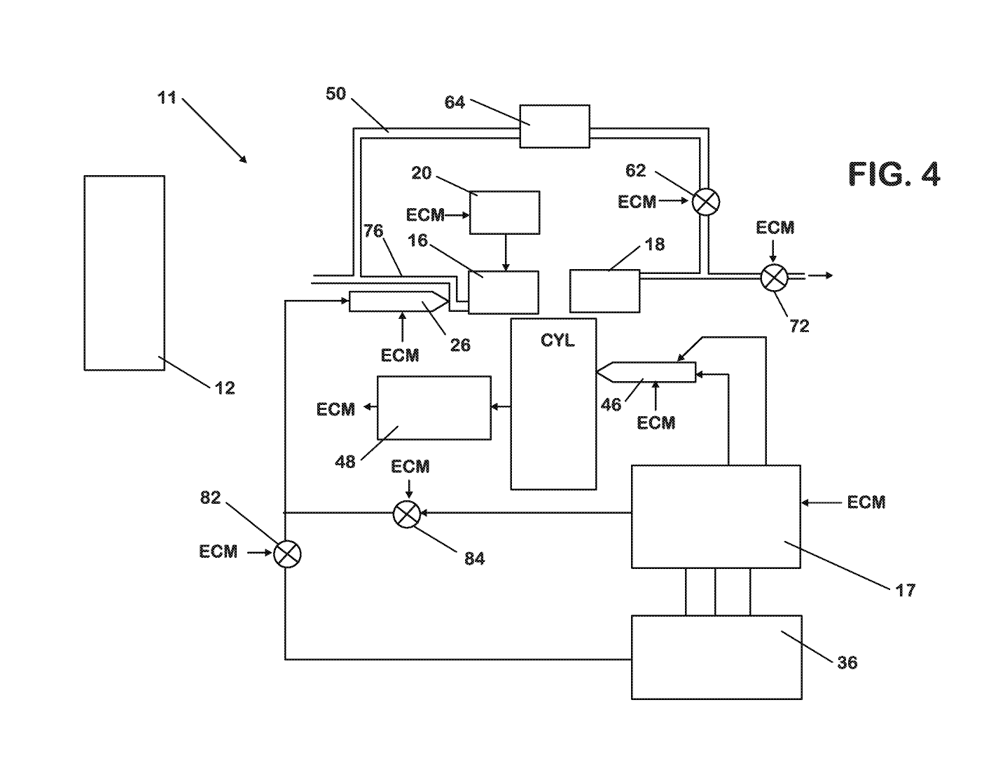

The possibility of adjusting the quantity of exhaust gas recirculated and thereby changing the proportions of fresh air, exhaust gas and fuel in the intake charge to suppress auto-ignition before direct injection of relatively high reactivity fuel at or near piston TDC allows the possibility of using single fuel in an auto-ignition engine with some of the fuel mixed into the intake charge. Engine system 11 of FIG. 4 illustrates such a system. Here the high reactivity fuel source 36 supplies both low and high pressure injection into the intake manifold 76 and directly into cylinder 21. Control valves 82 and 84 connect the manifold injector 26 with the fuel source 36 and the (high pressure) fuel injection pressurization system 17. Control valve 84 delivers fuel under pressure from a high pressure fuel injection system while valve 82 is used to adjust pressure to a lower level for manifold (or port) injection and to return surplus fuel to fuel source 36.

What is claimed is:

1. An engine system comprising:
a cylinder having an intake valve and an exhaust valve, with the cylinder providing for compression of a charge drawn through the intake valve for combustion in the cylinder;
an air induction sub-system connected to the intake valve;
a first fuel injector connected to inject a fuel into intake air from the air induction sub-system;
an exhaust gas recirculation line connecting exhaust gas purged through the exhaust valve to the air induction sub-system;
a recirculated exhaust gas cooler;
means for controlling recirculation of exhaust gas through the exhaust gas recirculation line and recirculated exhaust gas cooler to provide dilution and temperature control of the charge to suppress auto-ignition of the charge in the cylinder;
a variable valve actuator controlling opening and closing of the intake valve; and
a second fuel injector connected to inject fuel into the cylinder near a level of peak compression for auto ignition and combustion of the charge.

2. An engine system as claimed in claim 1, further comprising:
the first fuel injector being supplied from a source of relatively low reactivity fuel; and
the second fuel injector being supplied from a source of relatively high reactivity fuel.

3. An engine system as claimed in claim 2, the air induction sub-system further comprising:
a low pressure compressor and a high pressure compressor connected in series;
an intercooler coupled between the low pressure and the high pressure compressors; and
a charge air cooler coupled between the high pressure compressor and the intake valve.

4. An engine system as claimed in claim 3, further comprising:
a combustion phase sensor coupled to the cylinder; and
an engine control module coupled to receive combustion phase data from the combustion phase sensor and provide supervisory control over variable valve actuation timing, exhaust gas to charge air mixture ratios and charge air temperature.

5. An engine system as claimed in claim 4, further comprising the low reactivity fuel being gasoline and the high reactivity fuel being diesel.

6. An auto-ignition reciprocating engine system for a vehicle comprising:
an air induction sub-system providing for delivery of air to at least a first cylinder;
a low pressure fuel injector connected to inject a low reactivity fuel into the air induction sub-system;
means for recirculating exhaust gas from the at least first cylinder back to the air induction sub-system;
means for cooling recirculated exhaust gas;
means for controlling the quantity of exhaust gas recirculation to dilute and control the temperature of air in the air induction sub-system to suppress auto-ignition of a charge in the cylinder;
a high pressure fuel injector coupled directly into the cylinder to inject a high reactivity fuel at or near a level of peak compression for auto ignition and thereby to initiate combustion of the charge.

7. An auto-ignition reciprocating engine system as claimed in claim 6, further comprising:
means for variably actuating the intake valve to limit compression and cylinder peak temperature.

8. An auto-ignition reciprocating engine system as claimed in claim 7, further comprising:
means for boosting induction air pressure in the air induction sub-system.

9. A method of operating a reciprocating engine having at least a first cylinder, comprising the steps of:
drawing air from the environment and delivering it to at least a first cylinder as intake air;
injecting a low reactivity fuel into the intake air before delivery to the at least first cylinder;
means for recirculating and cooling exhaust gas from the at least first cylinder and mixing it with the intake air;
controlling the quantity of exhaust gas recirculation to dilute and control the temperature of air in the air induction sub-system to targets calculated to suppress auto-ignition of a charge in the cylinder; and
injecting a high reactivity fuel at or near a level of peak compression for auto ignition and thereby to initiate combustion of the charge.

10. A method as claimed in claim 9, comprising the further step of:
variably actuating the intake valve during draw strokes to limit compression and cylinder peak temperature.

11. A method as claimed in claim 10, comprising the further step of:
boosting intake air pressure to assure combustion at lean to stoichiometric levels.
